(19) United States
(12) Patent Application Publication
(10) Pub. No.: US 2020/0106806 A1
(43) Pub. Date: Apr. 2, 2020

(54) PREVENTING DISTRIBUTED DENIAL OF SERVICE ATTACKS IN REAL-TIME

(71) Applicant: VMware, Inc., Palo Alto, CA (US)

(72) Inventors: Ashutosh Gupta, San Jose, CA (US); Gaurav Rastogi, San Francisco, CA (US)

(21) Appl. No.: 16/584,414

(22) Filed: Sep. 26, 2019

Related U.S. Application Data
(60) Provisional application No. 62/737,599, filed on Sep. 27, 2018.

(51) Int. Cl. H04L 29/06; H04L 29/12; G06K 9/62; G06N 20/00

(52) U.S. Cl. CPC H04L 63/1458; H04L 63/1416; G06N 20/00; H04L 61/1511; G06K 9/6256; H04L 63/1425

(57) ABSTRACT

In an embodiment, a process for preventing distributed denial of service attacks in real-time includes sending received packets to a learning manager to detect a change in a traffic pattern. In response to the learning manager detecting the change in the traffic pattern, the process determines a set of Top-N analysis fields that corresponds to the change in the traffic pattern. The process performs Top-N analysis on received packets to determine a set of values associated with the set of Top-N analysis fields. The process obtains an updated policy based at least in part on the set of values, and checks incoming packets against the updated policy.

### CROSS REFERENCE TO OTHER APPLICATIONS

This application claims priority to U.S. Provisional Patent Application No. 62/737,599 entitled PREVENTING DDOS IN REAL-TIME filed Sep. 27, 2018 which is incorporated herein by reference for all purposes.

### BACKGROUND OF THE INVENTION

A distributed denial-of-service (DDoS) attack can affect many types of applications in a computer system. DDoS attacks impair the performance of a computer system by slowing down response time or incapacitating the system. Conventional techniques to prevent a DDoS attack tend to be indiscriminate and attempt to mitigate the effects of such attacks by preventing transactions all the time, which can be resource intensive. Thus, there is a need to prevent or reduce DDoS attacks while efficiently using available computational resources or reducing the amount of resources used.

### BRIEF DESCRIPTION OF THE DRAWINGS

Various embodiments of the invention are disclosed in the following detailed description and the accompanying drawings.

FIG. 1 is a block diagram illustrating an embodiment of a distributed network service platform.

FIG. 2 is a flow chart illustrating an embodiment of a process for preventing distributed denial-of-service attacks in real-time.

FIG. 3A shows an example of a controller training to detect a change in traffic pattern and build an attack model according to an embodiment of the present disclosure.

FIG. 3B shows an example of a service engine that prevents an attack in real time according to an embodiment of the present disclosure.

FIG. 4 is a diagram illustrating an embodiment of a controller and service engine configured to prevent distributed denial of service attacks in real time.

FIG. 5 shows an example of a service engine pipeline according to an embodiment of the present disclosure.

FIG. 6A shows an example of determining fields for Top-N analysis according to an embodiment of the present disclosure.

FIG. 6B shows an example of Top-N analysis according to an embodiment of the present disclosure.

FIG. 7 shows an example of detecting an attack based on non-existent domain requests.

FIG. 8 is a functional diagram illustrating a programmed computer system for executing preventing distributed denial-of-service attacks in real time in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications, and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

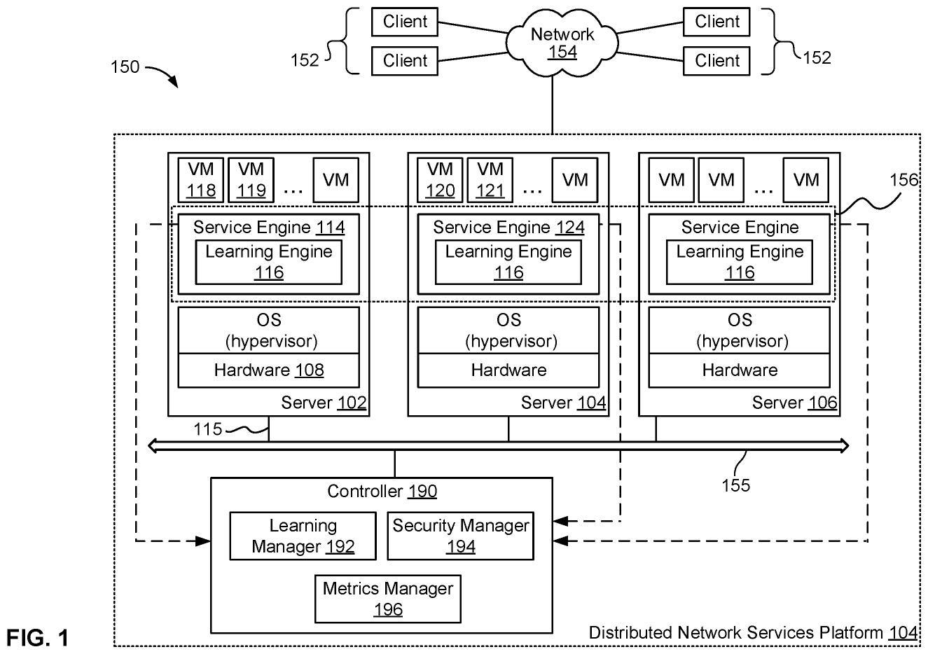

Computer applications including those serviced by distributed network services (further described with respect to FIG. 1) are vulnerable to distributed denial-of-service (DDoS) attacks. These types of attacks are volumetric in nature meaning that a high volume of traffic (requests/packets) are sent to a network. Because of the large number of requests, the network is overwhelmed when trying to respond to the requests. DDoS attacks are distributed because the request packets originate from many sources (IP addresses/networks). Conventionally, it is difficult to identify and prevent such attacks because monitoring only a few IP addresses is ineffective. A detection engine that monitors relatively few IP addresses would not recognize a pattern while a detection engine that monitors many IP addresses requires more memory, processing power, and computing resources. For this reason, conventional detection engines are either ineffective or exacerbates the problem of using many network resources leading to failure of the network because the processing resources needed to identify and prevent attacks exceeds the network's capability and causes the network to break down.

The techniques disclosed herein efficiently and accurately identify DDoS attacks. In addition, unlike conventional techniques, the ones disclosed herein can be applied in-line as requests come in or flow through the system (for example as part of load balancing) to prevent DDoS attacks in real-time. The disclosed techniques are chiefly described using the example of domain name system (DNS) DDoS attacks, but are not limited to such types of attacks. For example, the techniques can also be applied to other types of DDoS attacks by formulating appropriate policies for other types of traffic patterns. The DDoS prevention techniques described here can be applied to a distributed network such as the one shown in FIG. 1.

FIG. 1 is a block diagram illustrating an embodiment of a distributed network service platform 104. For context, a data center 150, external network 154, and clients 152 are also shown to illustrate how the distributed network service platform 104 interacts with clients 152. In this example, the distributed network service platform 104 is part of a data center 150. Controller 190 of the distributed network service platform communicates via network layer 155 to interact with clients 152 via external network 154.

The distributed network services platform may include many service engines distributed across several physical machines. The techniques described here can be performed in real-time or in-line meaning that they can be applied to incoming traffic to prevent security attacks. Each of the service engines 114, 124, etc. includes a learning engine 116. Controller 190 includes a learning manager 192 and security manager 194. An example of how the learning engine, learning manager, and security manager is implemented and a process by which DDoS attacks are prevented are further described below.

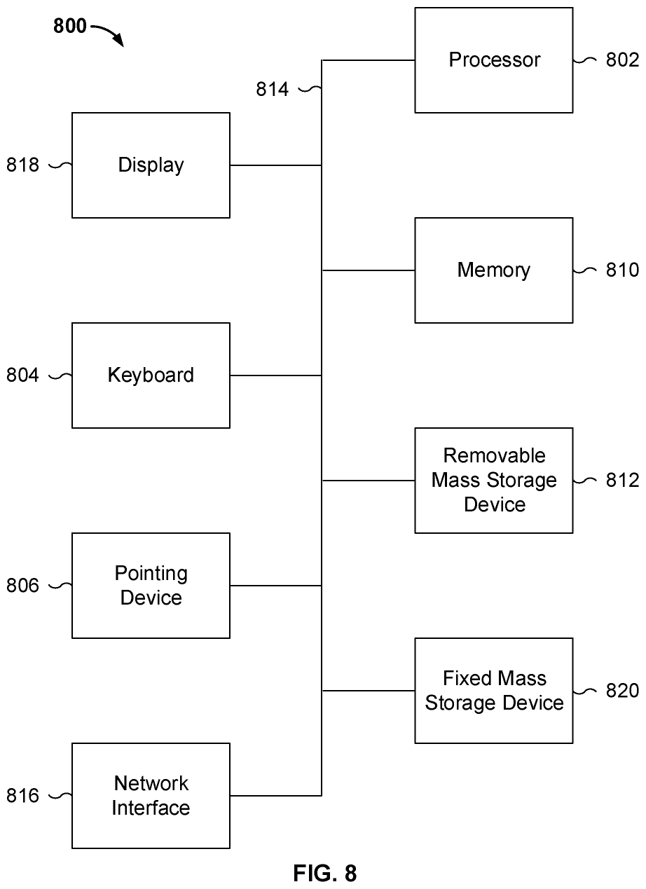

In this example, the platform 104 includes a number of servers configured to provide a distributed network service. A physical server (e.g., 102, 104, 106) has hardware components and software components, and may be implemented using a device such as device 800 shown in FIG. 8. In particular, hardware (e.g., 108) of the server supports operating system software in which a number of virtual machines (VMs) (e.g., 118, 119, 120, 121, etc.) are configured to execute. A VM is a software abstraction of a machine (e.g., a computer) that simulates the way a physical machine executes programs. The part of the server's operating system that manages the VMs is referred to as the hypervisor. The hypervisor interfaces between the physical hardware and the VMs, providing a layer of abstraction to the VMs. Through its management of the VMs' sharing of the physical hardware resources, the hypervisor makes it appear as though each VM were running on its own dedicated hardware. Examples of hypervisors include the VMware vSphere® Hypervisor.

In some embodiments, instances of network applications (not shown) are configured to execute within the VMs. Examples of such network applications include Web applications such as shopping cart, user authentication, credit card authentication, email, file sharing, virtual desktops, voice/video streaming, online collaboration, etc. As will be described in greater detail below, a distributed network service layer is formed to provide multiple application instances executing on different physical devices with network services. As used herein, network services refer to services that pertain to network functions, such as load balancing, authorization, content acceleration, analytics, application management, security including the techniques to prevent DDoS attacks disclosed herein, etc. As used herein, an application that is serviced by the distributed network service is referred to as a target application. Multiple instances of an application (e.g., multiple processes) can be launched on multiple VMs.

Inside the hypervisor there are multiple modules providing different functionalities. One of the modules is a virtual switch (not shown). A physical hardware has one or more physical ports (e.g., Ethernet ports 115). Network traffic (e.g., data packets) can be transmitted or received by any of the physical ports, to or from any VMs. The virtual switch is configured to direct traffic to and from one or more appropriate VMs, such as the VM in which the service engine on the device is operating.

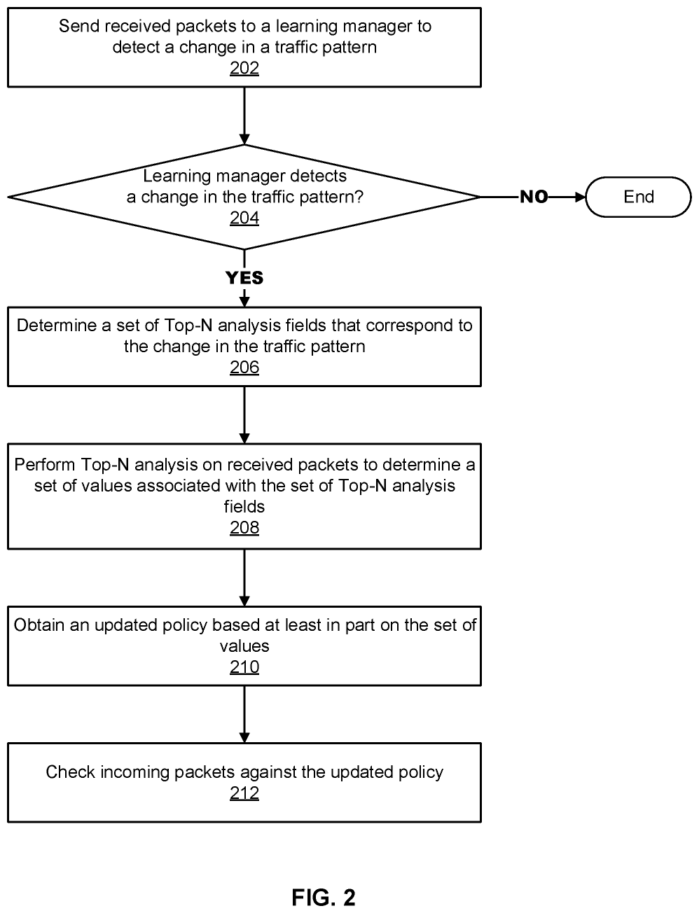

One or more service engines (e.g., 114) are instantiated on a physical device. In some embodiments, a service engine is implemented as software executing in a virtual machine. The service engine is executed to provide distributed network services for applications executing on the same physical server as the service engine, and/or for applications executing on different physical servers. In some embodiments, the service engine is configured to enable appropriate service components that implement service logic. For example, a load balancer component is executed to provide load balancing logic to distribute traffic load amongst instances of target applications executing on the local physical device as well as other physical devices. As another example, a firewall component is executed to provide firewall logic to instances of the target applications on various devices. As yet another example, a learning engine 116 is executed to prevent DDoS attacks for example by extracting features/characteristics from the service engine and perform anomaly detection or determine if the service engine is under attack and if so aspects of the attack as further described below with respect to FIG. 2. Many other service components may be implemented and enabled as appropriate. When a specific service is desired, a corresponding service component is configured and invoked by the service engine to execute in a VM.

In some embodiments, the performance of the target applications is monitored by the service engines, which are in turn monitored by controller 190. In some embodiments, all service engines maintain their own copy of current performance status of the target applications. A dedicated monitoring service engine is selected to send heartbeat signals (e.g., packets or other data of predefined format) to the target applications and update the performance status to other service engines as needed. For example, if a heartbeat is not acknowledged by a particular target application instance within a predefined amount of time, the monitoring service engine will mark the target application instance as having failed, and disseminate the information to other service engines. In some embodiments, controller 190 collects performance information from the service engines, analyzes the performance information, and sends data to client applications for display.

A virtual switch (not shown) inside the hypervisor interacts with the service engines, and uses existing networking Application Programming Interfaces (APIs) (such as APIs provided by the operating system) to direct traffic and provide distributed network services for target applications deployed on the network. The operating system and the target applications implement the API calls (e.g., API calls to send data to or receive data from a specific socket at an Internet Protocol (IP) address). As will be described in greater detail below, in some embodiments, the virtual switch is configured to be in-line with one or more VMs and intercept traffic designated to and from instances of the target applications executing on the VMs. When a networking API call is invoked, traffic is intercepted by the in-line virtual switch, which directs the traffic to or from the appropriate VM on which instances of the target application executes. In some embodiments, a service engine sends data to and receives data from a target application via the virtual switch.

A controller 190 is configured to control, monitor, program, and/or provision the distributed network services and virtual machines. In particular, the controller is configured to control, monitor, program, and/or provision a group of service engines, and is configured to perform functions such as bringing up the service engines, downloading software onto the service engines, sending configuration information to the service engines, monitoring the service engines' operations, detecting and handling failures, preventing security attacks, and/or collecting analytics information. The controller can be implemented as software, hardware, firmware, or any combination thereof. In some embodiments, the controller is deployed within the VM of a physical device or other appropriate environment. In some embodiments, the controller interacts with client applications to provide information needed by the user interface to present data to the end user, and with a virtualization infrastructure management application to configure VMs and obtain VM-related data. In some embodiments, the controller is implemented as a single entity logically, but multiple instances of the controller are installed and executed on multiple physical devices to provide high availability and increased capacity. In some embodiments, known techniques such as those used in distributed databases are applied to synchronize and maintain coherency of data among the controller instances.

Controller 190 is configured to help prevent DDoS attacks. In this example, the controller includes a learning manager 192, a security manager 194, and a metrics manager 196. Learning manager 192 consolidates coefficients from service engines (e.g., 114, 124, etc.) and generates an overall model at the virtual service level of attack probabilities and characteristics. For example, the learning manager outputs a machine learning model, decision tree, or the like that can be used to determine what dimensions/features on which to perform Top-N analysis. Top-N analysis can be performed to determine what was in common in the bad requests as further described below. The learning manager sends this information to the service engines. The security manager 194 performs Top-N analysis by consolidating the top pre-defined number (e.g., N) of factors from the services engines, determines what action to perform, and forms a policy for handling security attacks. In some embodiments, the security manager 194 periodically re-evaluates the policy and makes adjustments to improve security attack detection and prevention. Examples of and further details about the learning manager and security manager are described below.

In the example shown, the service engines cooperate to function as a single entity, forming a distributed network service layer 156 to provide services to the target applications. In other words, although multiple service engines (e.g., 114, 124, etc.) are installed and running on multiple physical servers, they cooperate to act as a single layer 156 across these physical devices. In some embodiments, the service engines cooperate by sharing states or other data structures. In other words, copies of the states or other global data are maintained and synchronized for the service engines and the controller.

In some embodiments, a single service layer is presented to the target applications to provide the target applications with services. The interaction between the target applications and service layer is transparent in some cases. For example, if a load balancing service is provided by the service layer, the target application sends and receives data via existing APIs as it would with a standard, non-distributed load balancing device. In some embodiments, the target applications are modified to take advantage of the services provided by the service layer. For example, if a compression service is provided by the service layer, the target application can be reconfigured to omit compression operations.

From a target application's point of view, a single service layer object is instantiated. The target application communicates with the single service layer object, even though in some implementations multiple service engine objects are replicated and executed on multiple servers.

Traffic received on a physical port of a server (e.g., a communications interface such as Ethernet port 115) is sent to the virtual switch. In some embodiments, the virtual switch is configured to use an API provided by the hypervisor to intercept incoming traffic designated for the target application(s) in an in-line mode, and send the traffic to an appropriate service engine. In in-line mode, packets are forwarded on without being replicated. The virtual switch passes the traffic to a service engine in the distributed network service layer (e.g., the service engine on the same physical device), which transforms the packets if needed and redirects the packets to the appropriate target application. The service engine, based on factors such as configured rules and operating conditions, redirects the traffic to an appropriate target application executing in a VM on a server.

Clients 152 may attempt to attack the data center 150 via network 154. In a DDoS attack on the distributed network service platform 104, for example, client(s) 152 send(s) packets to the distributed network service platform 104. The system is inundated with packets and becomes overwhelmed and unavailable to service requests including non-malicious requests. In an embodiment, the system prevents such attacks in real-time by learning from observed requests (e.g., DNS requests). A service engine (e.g., 114, 124, etc.) reports metrics to controller 190. The service engine has a learning engine 116 to extract features and detect anomalies in observed traffic. The service engine uses the extracted features and detected anomalies to determine whether the system is under attack. The controller has a metrics manager 196 to collect and aggregate metrics across services engines. The metrics may include characteristics such as response times, source information such as IP addresses, etc. The controller has a learning manager 192 to consolidate the features extracted from the collected metrics by the individual service engines. The controller has a security manager 194 to implement one or more policies to prevent DDoS attacks when traffic deviates from an expected pattern.

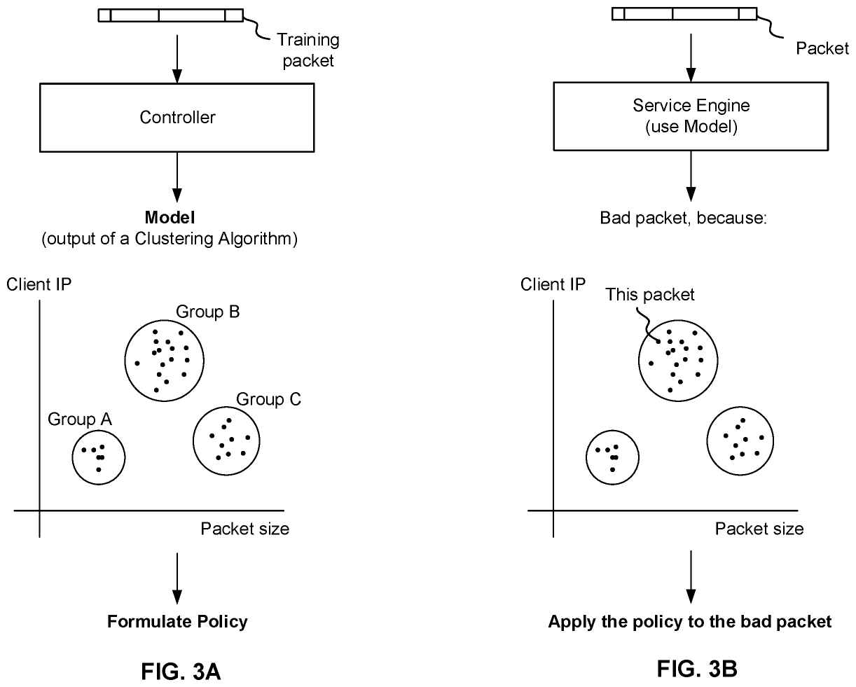

A process for preventing DDoS attacks in real-time is described in FIG. 2. The learning engine 116, learning manager 192, and security manager 194 are further described FIG. 3.

FIG. 2 is a flow chart illustrating an embodiment of a process for preventing distributed denial-of-service attacks in real-time. This process may be implemented on a distributed network services platform such as the one shown in FIG. 1. The process may be implemented by a service engine in cooperation with a controller such as the ones shown in FIG. 1 or a processor such as the one shown in FIG. 8. Portions of the process (e.g., 202-210) may be performed as part of an off-line training phase, and portions (e.g., 212) may be performed in real-time to prevent attacks.

In the example shown, the process begins by sending received packets to a learning manager to detect a change in a traffic pattern (202). Referring to the distributed network service platform shown in FIG. 1, a service engine (114, 124, etc.) receives traffic in the form of packets and sends the packets to learning manager 192 provided in controller 190. For example, the service engine receives packets that are part of a domain name system (DNS) request. The DNS request can be serviced by the service engine itself (where the service engine provides a DNS service and hosts DNS records) or can be forwarded to a back-end (third party) DNS server. The techniques disclosed herein can be applied in either scenario.

In various embodiments, the service engine services the DNS request by looking up the domain in the request to determine where to send the request. As part of servicing the DNS request, the service engine collects metrics related to the request. For example, if the DNS requests a domain that cannot be found (does not exist), then the service engine records this result or other aspects of the DNS request. In a DNS DDoS attack, the system is inundated with many DNS requests for non-existent domains, which impedes the system's ability to service other requests. For example, the system may drop other requests (including good ones) and be unable to service them.

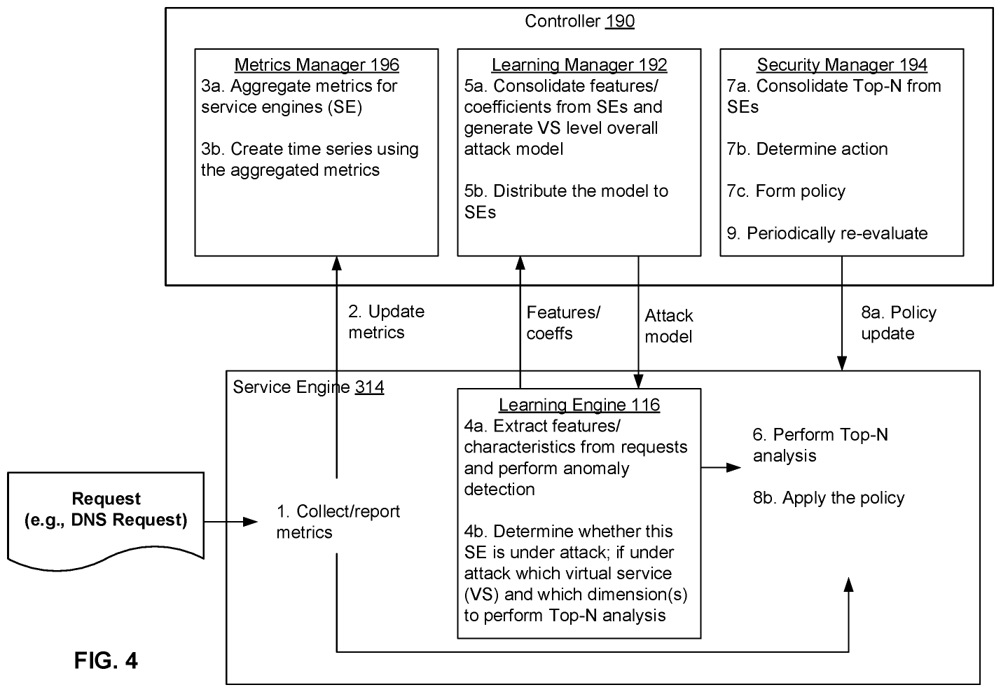

The learning manager detects whether there is a change in the traffic pattern (204). In various embodiments, the learning manager detects a change in traffic pattern using a machine learning model, clustering algorithm, neural network, or the like as further described with respect to FIG. 4. For example, the learning manager detects a change by comparing the current packet with packets received earlier during a pre-defined time period. Suppose that in a one-hour time slot, packets have typically been requests for existing (real domains). However, in the past two minutes, most packets have been requesting a non-existent domain indicating that the traffic pattern has changed.

A change in traffic pattern triggers the process to update a policy for handling packets in real time, which will improve the system's ability to prevent security attacks. In particular, the change in traffic pattern triggers the process to perform an analysis called Top-N analysis to determine factors/fields of received packets that correlate with the anomalies seen in traffic patterns. If the learning manager does not detect a change in a traffic pattern at 204, the process may simply end. Otherwise, the process proceeds to 206.

In response to the learning manager detecting the change in the traffic pattern, the process determines a set of Top-N analysis fields that corresponds to the change in the traffic pattern (206). The Nin Top-N is a fixed number such as 16, 32, 128, etc., and the fields are dimensions/factors on which to perform Top-N analysis such as header information such as a source IP address or a destination IP address, the time between requests, the size of a packet, anomalies such as thousands of DNS requests per second when usually hundreds of DNS requests are observed from a particular source, etc. So determining that a source IP address field should be used for Top-N analysis means that the packets will be analyzed by source IP address for example compiling the top 16 source IP addresses that requested non-existent domains.

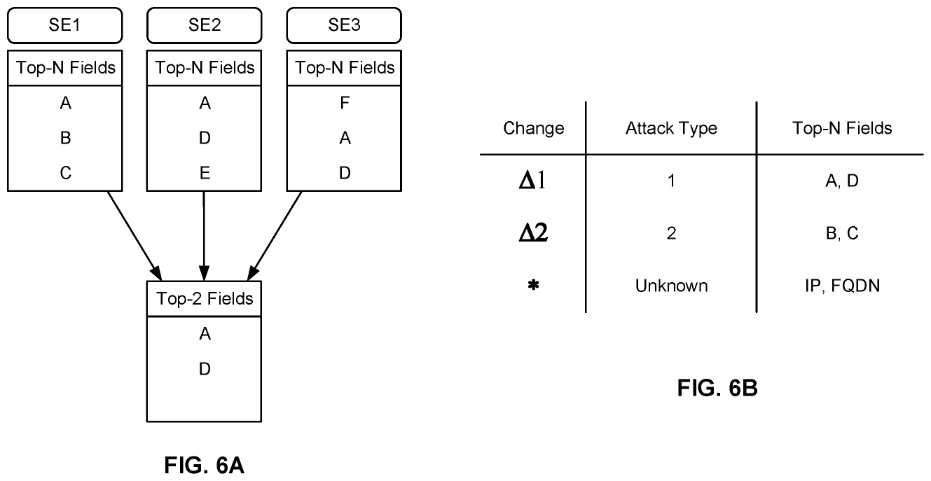

The set of Top-N analysis fields can be determined based on mapping the change in the traffic pattern to an attack type. An example of a mapping is shown in FIGS. 6A and 6B. Determining the attack type helps with mitigation because the solution to prevent one type of attack may be different from preventing another type of attack. For example, one type of attack is mitigated by dropping the packet including where/how early the packet can be dropped in the processing pipeline, while another solution to another type of attack is to rate limit by allowing some but not all packets through.

Since fields may be located on different layers in the packet (e.g., Transport layer, Application layer, etc.), the selection of fields for Top-N analysis defines which layer to use to determine whether the request corresponds to an attack. This can help the system to drop packets earlier because the system will look directly in the layer with the field of interest instead of systematically going through all layers. In other words, the Top-N analysis improves the functioning of a computer that performs this analysis to prevent security attacks because the Top-N analysis reduces processing cycles including by dropping the packet earlier than a process that does not use the Top-N analysis. In another aspect, determining a set of Top-N analysis fields improves the functioning of the system because the computing resources (processing and memory) are focused on the Top-N fields rather than performing analysis on all fields. That is, the most likely offenders as identified by the Top-N fields are further analyzed and other fields are not analyzed.

The process performs Top-N analysis on received packets to determine a set of values associated with the set of Top-N analysis fields (208). The output of Top-N analysis includes information about traffic patterns such as observing a request of a first type from a specific IP address X number of times along with a weight. The weight indicates a frequency of occurrence across service engines (e.g., four service engines have the same pattern). Top-N analysis is performed a specified duration of time (e.g., one hour). An example of Top-N analysis is further described with respect to FIGS. 6A and 6B.

For example, a clustering algorithm outputs a section of 500 requests and another section of 1000 requests. This information can be used to determine which section is bad by performing Top-N analysis on the first section of 500 requests and the second section of 1000 requests to see what was in common in the bad requests. One benefit is that Top-N analysis is not performed on everything (but instead is performed only on the top N), so computing resources are used efficiently.

The result is that the major offenders (top source IP addresses for example) are blocked from attacking the system. In various embodiments, the output of the Top-N analysis is a library of what to do with traffic that is seen (e.g., drop/block, rate limit, or pass). For example, the process performs Top-N analysis on the basis of client IP address, FQDN (a label corresponding to a website name conver10) client IPs sending these types of requests. The Top-N analysis can be performed off-line (e.g., during a training phase) or in-line with traffic as the traffic is received.

In various embodiments, the process sends a Top-N analysis result to a controller to be aggregated. Referring to FIG. 1, controller 190 aggregates the Top-N analysis results from service engines distributed across several physical devices. Each service engine may have a different view of the traffic. For example, one service engine may receive a request from a first IP address while another service engine receives a request from another IP address. The controller forms a policy about how to handle subsequent traffic based on the aggregated Top-N analysis results. The policy can depend a user's preference, e.g., to drop/block traffic from an IP address or rate-limit traffic (e.g., let through two requests per second).

The process obtains an updated policy based at least in part on the set of values (210). A policy defines actions to be taken in response to received traffic. Actions include blocking all traffic, rate limiting (e.g., letting in two requests/second), or allowing requests, and may be based on user preferences, history, and the like. The process updates the policy based on an aggregation of Top-N analysis performed by a plurality of service engines. Policies can be updated via a runtime object manager or other checkpoint. The runtime object manager or other checkpoint can maintain a state of the policy so that in case a controller goes down, SEs are informed and can still apply a policy.

The process checks incoming packets against the updated policy (212). In various embodiments, the incoming packets are checked in real time against the updated policy to determine whether an attack is occurring. Actions can be taken in accordance with the policy such as dropping packets from a specific IP address or FQDN.

In various embodiments, policies can be re-evaluated periodically to prevent them from becoming obsolete. The process of FIG. 2 can be repeated over later time periods to detect other changes to traffic patterns.

The next figure shows examples of a training phase in which a learning manager learns how to detect a change in a traffic pattern and build an attack model, and a runtime phase in which a service engine using the attack model to process packets.

FIG. 3A shows an example of a controller training to detect a change in traffic pattern and build an attack model according to an embodiment of the present disclosure. An example of the controller is controller 190 of FIG. 1. The controller receives a training packet that includes a header and a payload. The training packet is used to improve the controller's ability to observe anomalies in traffic and update policies to prevent attacks that involve packets similar to the training packet.

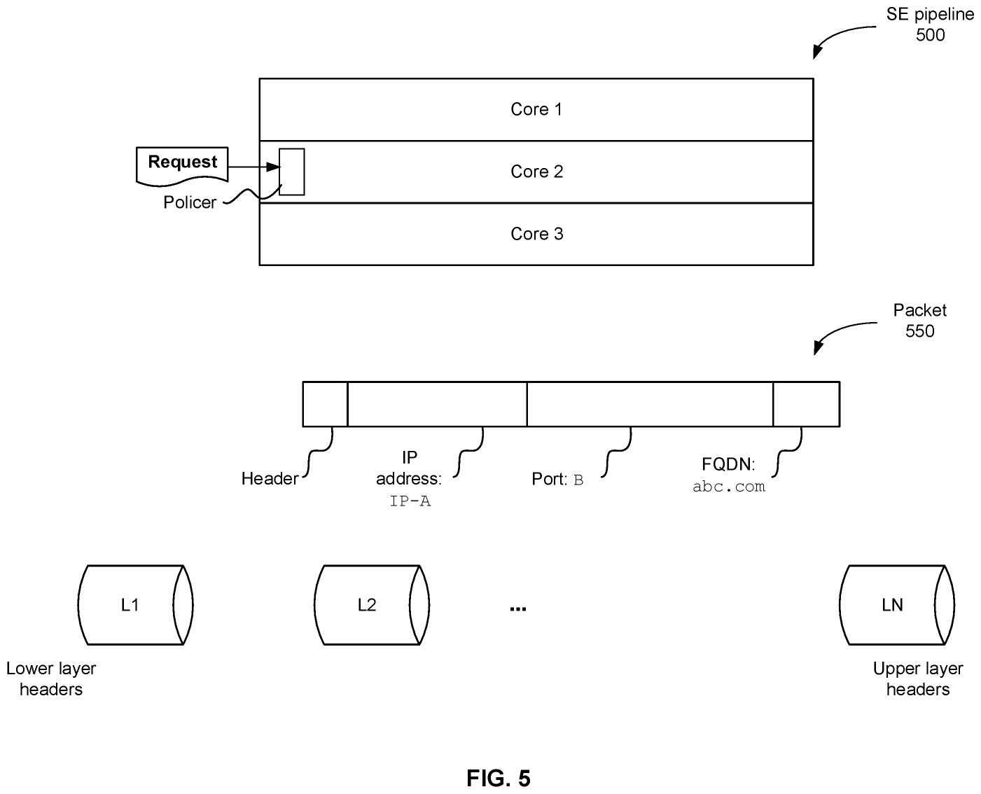

As further described with respect to FIG. 5, the packet can have information encoded on several layers. The training packet is used to train the controller to recognize a change in traffic patterns, which may indicate an attack. The controller (more specifically, a learning manager such as 192) can be trained in variety of ways including but not limited to using neural networks, linear networks, clustering algorithms, and machine learning models. In this example, the learning manager learns using a clustering algorithm that recognizes an attack by identifying clusters of data using principal component analysis. Here, the clustering algorithm determines that attack packets tend to fall into one of three groups: Group A, Group B, and Group C. Packets within a particular group have a similar client IP characteristic and a similar packet size. The output of the clustering algorithm is an attack model, which is represented by the graph showing the three groups. At runtime, a packet that falls into one of these groups will be considered a bad packet and handled according to a policy.

The controller (more specifically, a security manager such as 194) formulates a rate-limiting policy by which to handle bad packets. For example, if a packet falls into any of the three groups, the packet is dropped. Naturally, other policies (which may be tailored to a user's needs) are possible. For example, packets classified in Group A are rate limited at a first rate, packets classified in Group B are rate-limited at a second different rate, and packets classified in Group C are rate-limited at a third different rate.

FIG. 3B shows an example of a service engine that prevents an attack in real time according to an embodiment of the present disclosure. An example of the service engine is service engine 114, 124, etc. of FIG. 1. A controller distributes an attack model (such as the one in FIG. 3A) to the service engine. The service engine uses the attack model to determine if a packet is bad (the packet is part of an attack). The controller also distributes a policy to a service engine. The service engine applies the policy to received packets. This can improve the efficiency of packet processing. Unlike conventional techniques that deeply examine packets and ultimately rate limit the packet relatively late (after expending many resources), the policy informs the service of the most relevant layers of the packet to examine and thus the packet can be rate-limited after relatively shallow packet inspection. At the same time, the policy is accurate.

The service engine receives a packet, and determines that this packet falls into Group B of the attack model so this packet is bad. A good packet will have client IP and packet sizes dissimilar to Groups A, B, and C and so will not be classified as bad. Since this packet is bad, the service engine applies the policy to the bad packet to rate limit the bad packet for example dropping the packet.

The next figure shows an example with additional details of preventing distributed denial of service attacks in real time in the context of a controller and service engine.

FIG. 4 is a diagram illustrating an embodiment of a controller and service engine configured to prevent distributed denial of service attacks in real time. The controller and service engine may be part of a distributed network services platform such as the one shown in FIG. 1. The controller and service engine are configured to cooperatively perform the process shown in FIG. 2. For example, the service engine is configured to perform 202 and 206-212 while the controller is configured to perform 204. The numbered steps corresponding to the figure are also indicated below.

When the service engine 314 receives a request (such as a DNS request), the service engine collects metrics and reports the metrics to a metrics manager in controller 190 (1). In various embodiments, the service engine updates metrics before reporting them to the controller. For example, the service engine maintains a log of various metrics and aggregates or otherwise updates the various metrics with the new metrics associated with received request.

In response to receiving the metrics, the metrics manager aggregates the metrics for the service engines (3a). As shown in FIG. 1, controller 190 can be responsible for several service engines (114, 124, etc.). Each of the service engines may report metrics to the controller, and the controller will aggregate the metrics over the several service engines for which the controller is responsible. In various embodiments, the service engine collects metrics and sends them to the controller, more specifically to a metrics manager. Referring to the distributed network service platform shown in FIG. 1, a service engine (114, 124, etc.) collects metrics and sends them to metrics manager 196 in controller 190.

Metrics manager 196 aggregates metrics from the service engines and creates a time series of aggregations. In some embodiments, the metrics manager performs an anomaly detection algorithm to differentiate between normal traffic patterns and unusual traffic. For example, normal behavior is having two requests per second from a given source. The metrics manager will note that receiving 10 requests from the source is unusual and trigger the learning engine to perform additional processes to further analyze this situation.

After aggregating the metrics, the metrics manager creates a time series from the aggregated metrics (3b). In one aspect, time series data can be easily manipulated by a learning manager 192 to build an attack model representing the data (including possibly attacks) seen by the service engines. Metrics trigger the learning engine to perform feature extraction. This reduces the use of computational resources because the learning engine does not necessarily process every single request but instead is triggered by the metrics.

Service engine 314 is configured to extract features/characteristics from observed data and perform anomaly detection (4a). The service engine can extract features/characteristics such as the source/generator of the request, IP address, and the like. As described with respect to FIG. 2, feature extraction can performed off-line so as not to slow down the system at runtime.

A service engine extracts from the packets features and characteristics that may be useful for the learning manager to detect a change in a traffic pattern. For example, the service engine extracts features and characteristics from the request by determining aspects of an origin of the request such as a tool used to generate the request, an IP address that generated the request, and the like.

Learning manager 192 detects a change in the traffic pattern based on a feature of the received packets in various embodiments. A feature of the received packets can be determined based on a machine learning model. The machine learning model can be built using features collected by the service engines. The extracted features can be used to make predictions about whether subsequently received requests are good or bad (part of an attack) as well as the type of attack.

Individual service engine can report anomalies to the controller (learning manager 192) to help the controller identify changes in traffic patterns. For example, the service engine reports features/coefficients associated with possible anomalies to the learning manager.

The learning manager is trained to generate an attack model based on the traffic (5a). In various embodiments, the learning manager consolidates the features/coefficients reported by various service engines to general an overall attack model at the virtual service-level. The model can be generated in a variety of ways including but not limited to cluster algorithms, machine learning models, neural networks, linear networks, and vector analysis. For example, the learning manager performs vector analysis to identify whether factors indicate an attack. In various embodiments, the attack model is built based at least in part on analysis of a plurality of layers of packet data as further described with respect to FIG. 5.

Controller 190 distributes the attack model to the service engines (5b). The service engines then perform Top-N analysis on the dimensions from 4b and based on the attack model received from the controller (6). In various embodiments, the service engines perform analysis to determine the most likely/most frequent potential attackers. The top 10 (16, 32, 182, or any other number, N) requestors or FQDNs (domain/label for a website name) can be identified. Based on the Top-N analysis, one or more FQDNs can be blocked. Learning engine 116 helps to identify what Top N analysis to perform, because performing Top N analysis can be computationally expensive. The attack model informs how the attack can be mitigated. For example, the type of parameter can indicate where/when to drop the parameter or a request/source associated with the parameter. Anomalies can be detected by a state machine which assesses what is happening in the observed traffic.

Service engine 314 uses the attack model to perform Top-N analysis (6), and reports results to security manager 194. The security manager consolidates the Top-N from each of the service engines (7a), determines what actions to perform based on the analysis (7b) such as rate limiting, and forms a policy to carry out the actions (7c). Controller 190 distributes the policy to each of the service engines (8a) and the service engine 314 carries out the policy such as rate limiting (8b). In various embodiments, security manager 194 periodically re-evaluates the policy (9) to determine updates. For example, as traffic patterns change the policy may be updated to relax rate limiting rules for certain source IPs or to be more stringent about rate limiting for specific source IPs.

FIG. 5 shows an example of a service engine pipeline according to an embodiment of the present disclosure. The service engine can be configured to perform the techniques disclosed herein.

The service engine has three cores in this example. Each core runs one thread of packet processing, but there is a single point of entry at the policer. The policer is configured to apply a policy to request packets as they come in. The policy can be formulated by a controller according to the techniques disclosed here. The policer checks packet contents.

Example DNS query packet 550 includes, among others not shown, several components: a header, IP address, port, and FQDN. Some example values are listed for each of these components. These fields may be in different layers of the packet. Multiple layers of pipeline analysis can be performed to determine an attack model and prevent security attacks. Layers can be analyzed from lower layers to higher layers. For example, lower layer headers are examined (by L1) before upper layer headers are examined (by LN).

Conventionally, layer analysis is performed systematically so that an upper layer header such as FQDN is not examined until lower layer headers have already been examined. This means that a lot of resources can be expended on a bad packet. The techniques disclosed herein can quickly determine that a packet is bad. For example, an attack model may indicate that a FQDN is a good indicator of whether a packet is bad, so the service engine pipeline can look at the FQDN layer header before other layer headers to determine if the packet is good or bad.

FIG. 6A shows an example of determining fields for Top-N analysis according to an embodiment of the present disclosure. The service engine can be configured to perform the techniques disclosed herein to determine fields for performing Top-N analysis (e.g., 206).

When there is a change in traffic pattern, Top-N analysis is triggered so each service engine will determine fields that correspond to the change in traffic pattern. In this example, SE1 determines that its top fields are A, B, and C. SE2 determined that its top fields are A, D, and E, and SE3 determines that its top fields are F, A, and D. This information can be consolidated by a controller to determine the Top-2 fields for example. The two most frequently occurring fields are A and D, so these are the fields selected by the controller on which to perform Top-N analysis when traffic pattern change (41) corresponding to Attack Type 1 happens.

In the future, when traffic pattern change (41) happens, this indicates that Attack Type 1 is potentially happening and the SE will examine fields A and D in a newly received packet to determine whether Attack Type 1 is happening.

FIG. 6B shows an example of Top-N analysis according to an embodiment of a service platform as described herein. This mapping is formed using the selection of Top-N fields shown in FIG. 6A. A type of change in traffic pattern corresponds to an attack type and one or more Top-N fields. In this example, a first change (41) corresponds to Attack Type 1 (which can be determined by a controller using a machine learning model or the like as described above). In this situation, the Top-N fields to use are A and D. Sometimes a change in traffic pattern has an unknown attack type meaning a change is detected but it may be a new type of change and it is not yet known what type of attack this is. In this situation, pre-defined fields can be used such as IP address and FQDN. Over time, as more data is observed the fields can be refined.

In various embodiments, Top N analysis includes applying rules to fields such as applying Rule 1 on Field A, then applying Rule 2 on Field B, then applying Rule 3 on a combination of Field C and Field D. The process applies Top N analysis on the derived model to generate a policy. The policy can be applied to a sub-set of stages to incoming traffic to prevent security attacks.

There are many use cases for the techniques described above including, without limitation, preventing the following types of attacks: non-existent domain, FQDN with a large response size (above a threshold), and spoofing an IP address as a source (DNS resolver). The following figures show some examples of preventing a non-existent domain attack.

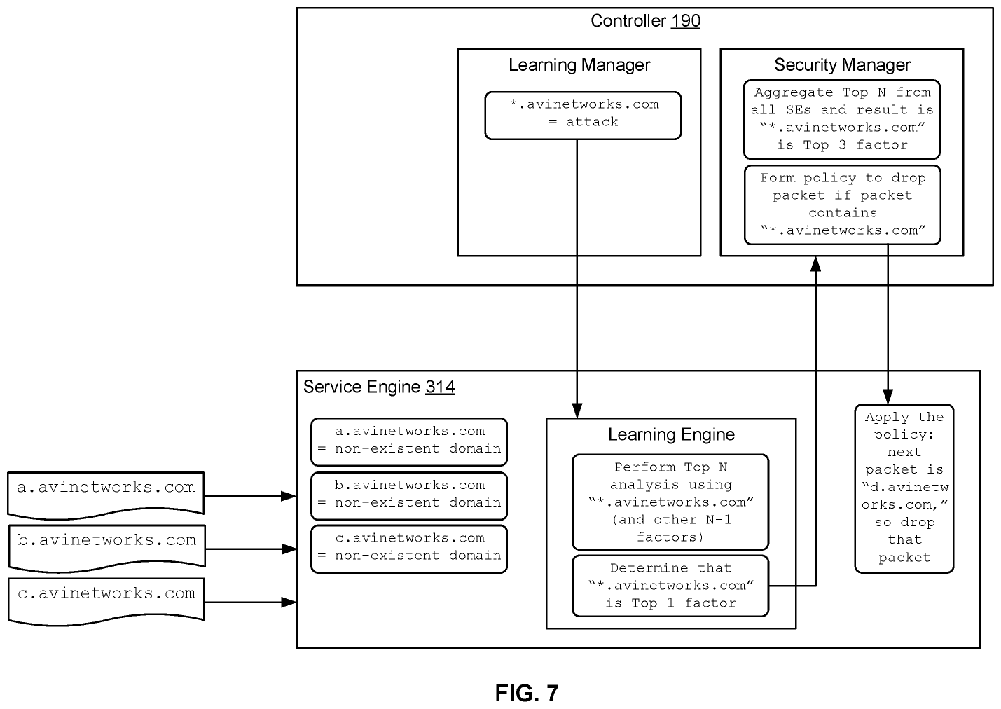

FIG. 7 shows an example of detecting an attack based on non-existent domain requests. The service engine receives a first packet containing “a.avinetworks.com,” and determines that the domain does not exist. In various embodiments, the service engine can collect the metrics and report them as a group to the controller or the service engine can report them individually to the controller. For example, the service engine can report that “a.avinetworks.com” is a non-existent domain, then later report “b.avinetworks.com” is a non-existent domain, etc. Alternatively, the service engine can collect all of the information and report that “a.avinetworks.com,” “b.avinetworks.com,” and “c.avinetworks.com” are non-existent domains together to the controller. Although in this example all three requests are shown as being sent to a single service engine, the packets can instead by sent to several service engines. In either case, the learning manager is able to identify that they are part of an attack.

Various features can be extracted from the “a.avinetworks.com” example. Example features include the length, number of digits (here all are alphabet characters so the number of digits is 0), the number of labels (3: “a,” “avinetworks,” and “com”), and the occurrence of highly probable keys. “com” is an example of a highly probable key for FQDN. In various embodiments, a list of highly probable keys is maintained and updated based on domain knowledge.

The controller (more specifically, the learning manager) generates an overall virtual service level model based on this information. The virtual service level model indicates that “*.avinetworks.com” is an attack meaning that a common prefix (anything) preceding “avinetworks.com” is a non-existent domain and therefore part of an attack. The learning manager sends a result of this overall model (e.g., that “*.avinetworks.com” is a factor for Top-N analysis) to the learning engine in the service engine.

The learning engine performs Top-N analysis using this factor (“*.avinetworks.com”) along with other factors. Since one factor is “*.avinetworks.com,” there are N-1 other factors that are used for Top-N analysis. In this example, “*.avinetworks.com” is the top factor meaning that the most common reason for an attack is this type of request/packet. This information is sent to the security manager in the controller.

The controller aggregates the Top-N analysis results from all of the service engines, and in this example the factor “*.avinetworks.com” is one of the top 3 correlations with an attack. Thus, the controller forms (or updates) a policy to drop a packet if the packet contains “*.avinetworks.com.” This policy (or policy update) is distributed to the individual service engines so that the service engines can process subsequently-received traffic accordingly.

Suppose a service engine then receives a packet with “d.avinetworks.com.” The policy indicates that this packet should be dropped, so the service engine drops this packet and successfully prevents an attack.

FIG. 8 is a functional diagram illustrating a programmed computer system for executing preventing distributed denial-of-service attacks in real time in accordance with some embodiments. As will be apparent, other computer system architectures and configurations can be used to prevent security attacks. Computer system 800, which includes various subsystems as described below, includes at least one microprocessor subsystem (also referred to as a processor or a central processing unit (CPU)) 802. For example, processor 802 can be implemented by a single-chip processor or by multiple processors. In some embodiments, processor 802 is a general purpose digital processor that controls the operation of the computer system 800. Using instructions retrieved from memory 810, the processor 802 controls the reception and manipulation of input data, and the output and display of data on output devices (e.g., display 818). In some embodiments, processor 802 includes and/or is used to provide a service engine such as 114 and 124 or controller 190 and/or execute/perform the processes described above with respect to FIGS. 2 and 4.

Processor 802 is coupled bi-directionally with memory 810, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 802. Also as is well known in the art, primary storage typically includes basic operating instructions, program code, data, and objects used by the processor 802 to perform its functions (e.g., programmed instructions). For example, memory 810 can include any suitable computer-readable storage media, described below, depending on whether, for example, data access needs to be bi-directional or uni-directional. For example, processor 802 can also directly and very rapidly retrieve and store frequently needed data in a cache memory (not shown).

A removable mass storage device 812 provides additional data storage capacity for the computer system 800, and is coupled either bi-directionally (read/write) or uni-directionally (read only) to processor 802. For example, storage 812 can also include computer-readable media such as magnetic tape, flash memory, PC-CARDS, portable mass storage devices, holographic storage devices, and other storage devices. A fixed mass storage 820 can also, for example, provide additional data storage capacity. The most common example of mass storage 820 is a hard disk drive. Mass storage 812, 820 generally store additional programming instructions, data, and the like that typically are not in active use by the processor 802. It will be appreciated that the information retained within mass storage 812 and 820 can be incorporated, if needed, in standard fashion as part of memory 810 (e.g., RAM) as virtual memory.

In addition to providing processor 802 access to storage subsystems, bus 814 can also be used to provide access to other subsystems and devices. As shown, these can include a display monitor 818, a network interface 816, a keyboard 804, and a pointing device 806, as well as an auxiliary input/output device interface, a sound card, speakers, and other subsystems as needed. For example, the pointing device 806 can be a mouse, stylus, track ball, or tablet, and is useful for interacting with a graphical user interface.

The network interface 816 allows processor 802 to be coupled to another computer, computer network, or telecommunications network using a network connection as shown. For example, through the network interface 816, the processor 802 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 802 can be used to connect the computer system 800 to an external network and transfer data according to standard protocols. For example, various process embodiments disclosed herein can be executed on processor 802, or can be performed across a network such as the Internet, intranet networks, or local area networks, in conjunction with a remote processor that shares a portion of the processing. Additional mass storage devices (not shown) can also be connected to processor 802 through network interface 816.

An auxiliary I/O device interface (not shown) can be used in conjunction with computer system 800. The auxiliary I/O device interface can include general and customized interfaces that allow the processor 802 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 8 is but an example of a computer system suitable for use with the various embodiments disclosed herein. Other computer systems suitable for such use can include additional or fewer subsystems. In addition, bus 814 is illustrative of any interconnection scheme serving to link the subsystems. Other computer architectures having different configurations of subsystems can also be utilized.

The techniques disclosed herein have many advantages over conventional techniques. In one aspect, the disclosed techniques can be applied to distributed systems, which have many service engines provided in several different physical devices. In another aspect, the disclosed techniques (including Top-N analysis) can be applied in real-time or in-line as traffic passes through the system. Learning is performed across distributed service engines, and the result of the learning is applied in real-time by the individual service engines to prevent security attacks.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method comprising:
sending received packets to a learning manager to detect a change in a traffic pattern;
in response to the learning manager detecting the change in the traffic pattern, determining a set of Top-N analysis fields that corresponds to the change in the traffic pattern;
performing Top-N analysis on received packets to determine a set of values associated with the set of Top-N analysis fields;
obtaining an updated policy based at least in part on the set of values; and
checking incoming packets against the updated policy.

2. The method of claim 1, wherein the learning manager is trained to generate an attack model based on the traffic.

3. The method of claim 2, wherein the attack model is based at least in part on analysis of a plurality of layers of packet data.

4. The method of claim 1, further comprising sending a Top-N analysis result to a controller to be aggregated.

5. The method of claim 1, wherein the received packets correspond to a domain name service (DNS) request.

6. The method of claim 5, wherein the DNS request is for a non-existent domain.

7. The method of claim 1, wherein the received packets correspond to a fully qualified domain name (FQDN) with a response size larger than a threshold.

8. The method of claim 1, wherein the change in the traffic pattern is based at least in part on extracting a feature of the received packets.

9. The method of claim 8, wherein the feature of the received packets is determined based at least in part on a machine learning model.

10. The method of claim 1, wherein the determination of a set of Top-N analysis fields is based at least in part on mapping the change in the traffic pattern to an attack type.

11. The method of claim 1, wherein the Top-N analysis defines which layer to use to determine whether the request corresponds to an attack.

12. The method of claim 1, wherein the Top-N analysis reduces processing cycles including by dropping the packet earlier than a process that does not use the Top-N analysis.

13. The method of claim 1, wherein the updated policy is based at least in part on an aggregation of Top-N analysis performed by a plurality of service engines.

14. The method of claim 13, wherein the plurality of service engines is distributed across a plurality of physical devices.

15. The method of claim 14, wherein the aggregated Top-N analysis is a model at a virtual service level.

16. The method of claim 1, wherein the checking of incoming packets against the updated policy is performed in real time to received packets to determine whether an attack is occurring.

17. A system comprising:
a service engine configured to:
send received packets to a learning manager to detect a change in a traffic pattern;
in response to the learning manager detecting the change in the traffic pattern, determine a set of Top-N analysis fields that corresponds to the change in the traffic pattern;
perform Top-N analysis on received packets to determine a set of values associated with the set of Top-N analysis fields;
obtain an updated policy based at least in part on the set of values; and
check incoming packets against the updated policy; and
a memory coupled to the service engine, the memory configured to provide the service engine with instructions.

18. A computer program product embodied in a non-transitory computer readable storage medium and comprising computer instructions for:
sending received packets to a learning manager to detect a change in a traffic pattern;
in response to the learning manager detecting the change in the traffic pattern, determining a set of Top-N analysis fields that corresponds to the change in the traffic pattern;
performing Top-N analysis on received packets to determine a set of values associated with the set of Top-N analysis fields;
obtaining an updated policy based at least in part on the set of values; and
checking incoming packets against the updated policy.
